(19) United States
(12) Patent Application Publication
(10) Pub. No.: US 2023/0102373 A1
(43) Pub. Date: Mar. 30, 2023

(54) WHEELCHAIR GRAB RAIL

(71) Applicants: Andrew Katz, Ottawa (CA); Rebecca Cooney, Ottawa (CA); Robert Platts, Ottawa (CA)

(72) Inventors: Andrew Katz, Ottawa (CA); Rebecca Cooney, Ottawa (CA); Robert Platts, Ottawa (CA)

(21) Appl. No.: 17/488,405

(22) Filed: Sep. 29, 2021

(51) Int. Cl. A61G 5/14

(52) U.S. Cl. CPC A61G 5/14

(57) ABSTRACT

The invention is a grab rail built onto or attachable onto a wheelchair, having a cross rail reachably above the seated user and forward of the seated user's center of gravity which joins into side rails above the sides of the wheelchair, with support bars extending downward from the rear ends of the side bars to attach rigidly atop the wheelchair's back rest, the grab rail helping the user reposition or transfer independently. The grab rail does not obstruct or interfere with indoor use and can also support a canopy for sun and rain protection outdoors.

### TECHNICAL FIELD

Helping wheelchair users reposition or transfer themselves independently.

### BACKGROUND OF THE INVENTION

A wheelchair user's daily living involves repeatedy shifting position just for comfort or for transfers as such as to and from bed. That's all done more easily and safely-and more independently, without assistance-if there's something overhead to grab onto.

### SUMMARY OF THE PREFERRED EMBODIMENT OF THE INVENTION

The present invention is a grab rail built onto or attachable onto a wheelchair, the grab rail formed as: a top grab part consisting of a cross rail extending horizontally across the wheelchair, reachably above a seated user head and forward of the user's center of gravity; a side rail above each side of the wheelchair, each side rail extending horizontally rearward from one end of the cross rail; and a support bar extending downward from the rear end of each side bar, each support bar terminating at either a handle part (“push handle”), where the wheelchair is so equipped, or at the top of a structural side of the wheelchair's back rest.

Considering wheelchairs having rearward-facing push handles, attachment of the grab rail is accomplished using two joiners, each joiner having a forward-facing sleeve part formed to slide over and lock to a push handle and an upward-facing sleeve part into which the bottom end of the support bar is inserted and locked, thereby holding each support bar and the whole grab rail rigidly over the wheelchair. The joiners themselves preferably have a handle extending further rearward, since the joiners' forward-facing sleeves cover the wheelchair's own push handle handles.

Now considering those wheelchairs without push handles, attachment of the grab rail is preferably accomplished by special joiners which each have a downward-extending clamp lockable side-on over the strong near-vertical side framing of the back rest, and an upward-facing sleeve part into which the bottom ends of the grab rail's support bars are inserted and locked. (Push handles and side rails are adequately strong for this usage.)

In either case, the grab rail does not interfere with wheelchair maneuvering, through doorways as a crucial example, but can be removed by lifting its support bars out of the joiners if and when not needed.

Independence is expanded, a main example being ability to use a transfer board to shift oneself-given just one able arm-onto and off the chair with no assistance.

In a further usage, an umbrella-like canopy can be attached over the top of the grab rail to offer sun and rain protection for the user, while not obstructing the grab function.

In a still-further possibility, at least with power wheelchairs, the grab rail could be reversed in its joiners so that its top grab part cantilevers out behind the wheelchair, providing high and potentially adequately strong anchorage for a winch to be attached to it for lifting a fallen person off the floor to safe seating height.

### BRIEF DESCRIPTION OF THE DRAWINGS

FIG. 1 is a perspective sketch of the grab rail ready to mount on wheelchairs with rearward-extending push handles.

FIG. 2 is a side elevation of the grab rail mounted on a wheelchair having no push handles.

### DETAILED DESCRIPTION

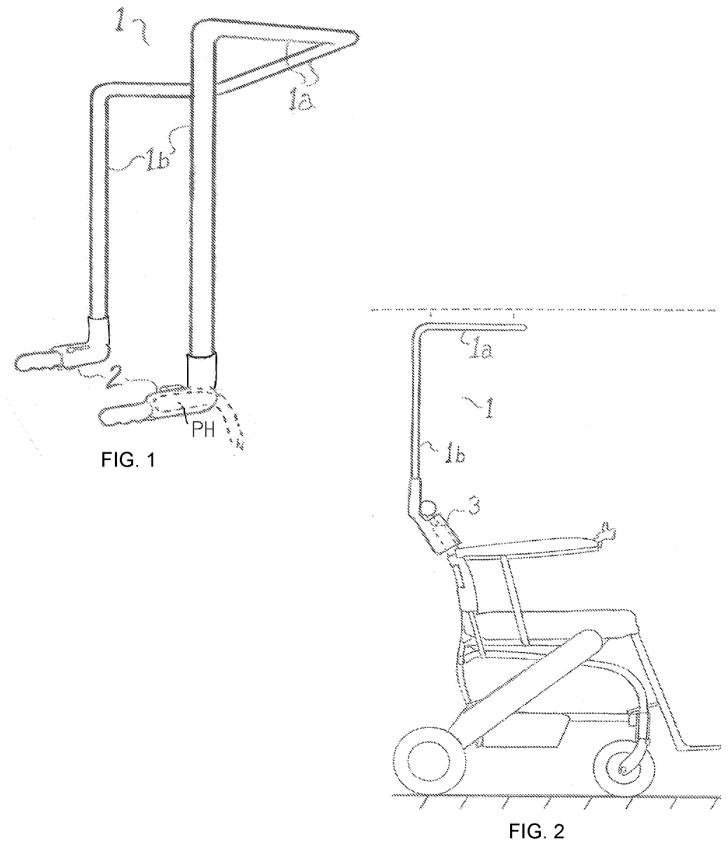

FIG. 1 shows the grab rail 1 with its overhead grab bars 1a and vertical support bars 1b, the latter inserted detachably into an upward-facing sleeve part of the joiner 2, and the joiner 2 having a forward-facing sleeve part ready to slide over and lock to a wheelchair's rearward-extending push handles PH (dashed lines) to secure the grab rail 1 on the wheelchair. In some cases it is best to first remove the push handle's “cushioning” sleeve from the handle bar before sliding the joiner over it. Thumb screws can be seen near the tops of the joiners 2. The size and shape of wheelchair push handles vary little, but the best positioning of thumb screws is not always the same, so provision of spare threaded holes in each joiner 2 is advisable. One thumb screw or set screw should force the rear of the push handle PH down against the rear interior “floor” of the joiner 2, while another forces the forward part of the push handle (just ahead of its cushioning sleeve, if present) up against the front interior “ceiling” of the joiner 2, imparting maximum strength and rigidity to withstand a user's downward pull on the crossbar of the overhead grab.

The joiners 2 obstruct the push handles PH, so the joiners 2 themselves may best include push handle extensions as shown.

FIG. 2 shows the grab rail 1 installed on a power wheelchair having no push handles, each of the grab rail's support bars 1b being inserted down into an upward facing sleeve of a special joiner 3, which joiner 3 has a lower clamp part clasping sideways inward over the upper portion of the sides of the wheelchair's back rest.

The dashed line over the grab rail 1, in FIG. 2, suggests the opportunity to use the grab rail 1 to support a sunshade over the wheelchair user.

We claim:

1. a grab rail built onto or attachable onto a wheelchair, having:
a cross rail extending horizontally across the wheelchair reachably above a seated user's head and forward of the user's center of gravity;
a side rail extending horizontally rearward from each end of the cross rail along each side of the wheelchair, each side rail ending above one side of the wheelchair's back rest;
support bars extending downward from the rear ends of the side bars, each support bar terminating at and secured to a push handle, where the wheelchair is equipped with such, or to the top of the side posts of the back rest, thereby securing the whole grab rail to the wheelchair.

2. A grab rail according to claim 1 wherein its attachment to a wheelchair having rearward-facing push handles is accomplished using separate joiners, one for each push handle, each joiner comprised of a forward-facing sleeve part which is slid over and locked to the push handle and an upward-facing sleeve part into which the bottom end of the support bar is inserted and locked, thereby holding the two support bars and the whole grab rail rigidly up and over the wheelchair.

3. A grab rail according to claim 2 wherein each joiner has its own handle extending further rearward, since the joiner's forward-facing sleeve covers the wheelchair's own push handle.

4. A grab rail according to claim 1 wherein its attachment to a wheelchair having no push handles is accomplished using separate joiners, each comprised of a downward-extending clamp locked side-on over the strong near-vertical side framing of the wheelchair's back rest, each joiner having an upward-facing sleeve part into which the bottom ends of the grab rail's support bars are inserted and locked.
